(19) United States
(12) Patent Application Publication
(10) Pub. No.: US 2024/0169315 A1
(43) Pub. Date: May 23, 2024

(54) REGISTRY OF ENTITIES OPTING INTO A UNIVERSAL CONTRACT

(71) Applicant: CRUSHCONTRACTS, INC., Barrington, IL (US)

(72) Inventor: Rumisa Khalid KHAN, Barrington, IL (US)

(73) Assignee: CRUSHCONTRACTS, INC., Barrington, IL (US)

(21) Appl. No.: 18/518,537

(22) Filed: Nov. 23, 2023

Related U.S. Application Data
(60) Provisional application No. 63/427,722, filed on Nov. 23, 2022.

(51) Int. Cl. G06Q 10/10

(52) U.S. Cl. CPC G06Q 10/10; G06Q 2220/00

(57) ABSTRACT

The technology disclosed relates to a universal contract roster and an opt-in network. In particular, the technology disclosed relates to setting up a universal contract. The universal contract is configured to represent a family of contract variants, and has universal terms and conditions that are binding across a multitude of transactions. The technology disclosed further relates to receiving respective opt-ins from respective entities into the universal contract, and constructing an opt-in network of the respective entities such that the universal contract is binding across respective transactions between an executing entity and the respective entities, without a need of executing respective contracts for the respective transactions between an executing entity and the respective entities.

### PRIORITY APPLICATION

This application claims the benefit of and priority to U.S. Provisional Patent Application No. 63/427,722, titled “GlobalNDA,” filed Nov. 23, 2022 (Attorney Docket No. ROMA1000USP01).

### FIELD OF THE TECHNOLOGY DISCLOSED

The technology disclosed relates to artificial intelligence type computers and digital data processing systems and corresponding data processing methods and products for emulation of intelligence (i.e., knowledge based systems, reasoning systems, and knowledge acquisition systems); and including systems for reasoning with uncertainty (e.g., fuzzy logic systems), adaptive systems, machine learning systems, and artificial neural networks. In particular, the technology disclosed relates to a registry, roster, or directory of entities opting into a universal contract that may form an opt-in network.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Contract overabundance is a common problem in contract management, especially when dealing with large volumes of contracts from different sources and formats. An opportunity arises to use a centralized solution to technically solve the problem of contract overabundance. More details follow.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 illustrates an architectural level schematic of a system in accordance with one implementation of the technology disclosed.

FIG. 2 shows one implementation of the disclosed universal contract construction.

FIG. 3 portrays one implementation of the disclosed opt-in network.

FIG. 4 depicts one implementation of a computer-implemented method of the technology disclosed.

FIG. 5 shows an example computer system that can be used to implement the technology disclosed.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general purpose signal processor or a block of random access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between. Wherever practicable, similar or like reference characters are used in the drawings to indicate similar or like functionality.

### System Overview

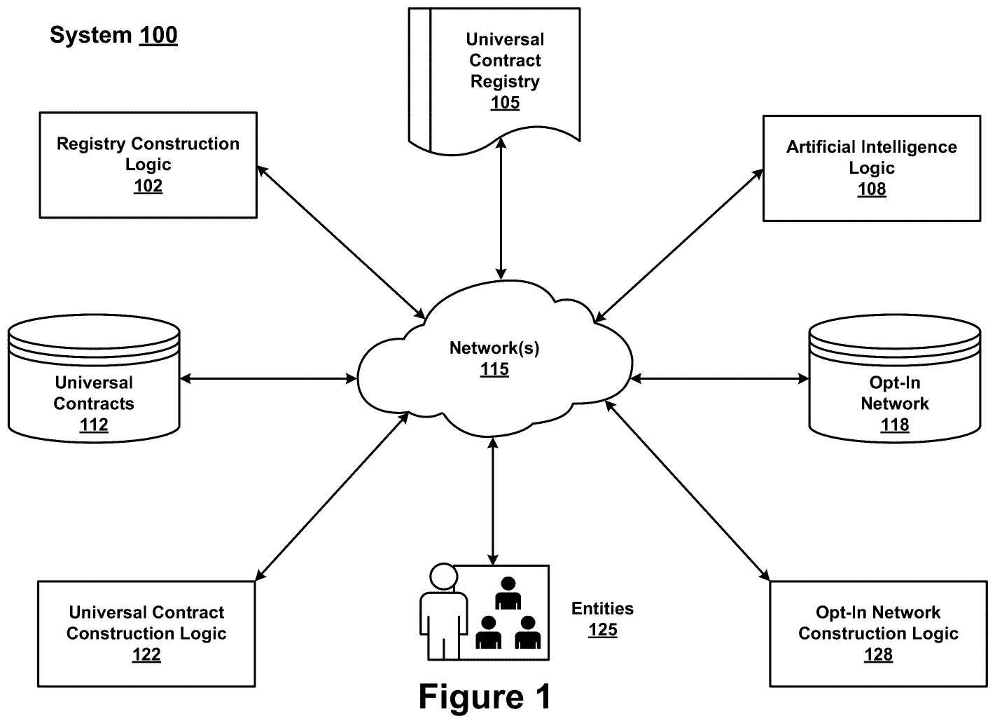

FIG. 1 illustrates an architectural level schematic of a system 100 in accordance with one implementation of the technology disclosed. We describe a system and various implementations for providing a registry, roster, or directory of entities opting into a universal contract that may form an opt-in network. The system and processes will be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the system will be described in greater detail.

FIG. 1 includes the system 100. The system 100 includes a registry construction logic 102, a registry, roster, or directory of entities opting into a universal contract 105, an artificial intelligence logic 108, universal contracts 112, an opt-in network 118, a universal contract construction logic 122, entities 125, and an opt-in network construction logic 128. In some implementations, the universal contracts 112 and the opt-in network 118 can store information from one or more tenants into tables of a common database image to form an on-demand database service (ODDS), which can be implemented in many ways, such as a multi-tenant database system (MTDS). A database image can include one or more database objects. In other implementations, the databases can be relational database management systems (RDBMSs), object-oriented database management systems (OODBMSs), distributed file systems (DFS), no-schema database, or any other data storing systems or computing devices.

The interconnection of the elements of the system 100 will now be described. The network(s) 115 couples the various components of the system 100, which are in communication with each other (indicated by solid lines). The actual communication path can be point-to-point over public and/or private networks. All of the communications can occur over a variety of networks, e.g., private networks, VPN, MPLS circuit, or Internet, and can use appropriate APIs and data interchange formats, e.g., REST, JSON, XML, SOAP and/or JMS. All of the communications can be encrypted. This communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX. Additionally, a variety of authorization and authentication techniques, such as username/password, OAuth, Kerberos, SecureID, digital certificates, and more, can be used to secure the communications.

The various components of the system 100 can include one or more computers and computer systems coupled in communication with one another. They can also be one or more virtual computing and/or storage resources. For example, the opt-in network 118 can be one or more Amazon EC2 instances and the registry, roster, or directory of entities opting into a universal contract 105 can be an Amazon S3™ storage. Other computing-as-service platforms such as Force.com from Salesforce, Rackspace, or Heroku could be used rather than implementing the opt-in network 118 on direct physical computers or traditional virtual machines. Additionally, to implement the opt-in network 118, one or more engines can be used, and one or more points of presence (POPs) can be established. The engines can be of varying types including a workstation, server, computing cluster, blade server, server farm, or any other data processing system or computing device. The engine can be communicably coupled to the databases via a different network connection. For example, the registry construction logic 102 can be coupled via the network(s) 115 (e.g., the Internet), the universal contract construction logic 122 can be coupled via a direct network link and the opt-in network construction logic 128 can be coupled by yet a different network connection. In other examples, the opt-in network 118 POPs can be distributed geographically and/or co-hosted with particular cloud services. Similarly, the registry, roster, or directory of entities opting into a universal contract 105 POPs can be distributed geographically. The two types of POPs can be either separately hosted or co-hosted as well.

As used herein, a cloud network or a hosted service or a cloud service or a cloud application or a cloud storage provider or a cloud storage application or a cloud computing service (CCS) is referred to as an “independent data store”, and vice-versa. Also as used herein, a cloud service, sometimes also referred to as a cloud computing service (CCS), or a hosted service or a cloud application refers to a network cloud service or application, web-based (e.g., accessed via a uniform resource locator (URL)) or native, such as sync clients. Examples include software as a service (SaaS) offerings, platform as a service (PaaS) offerings, and infrastructure as a service (IaaS) offerings, as well as internal enterprise applications that are exposed via URLs. Examples of common cloud services today include Salesforce.com™, Box™ Dropbox™, Google Apps™, Amazon AWS™, Microsoft Office 365™, Workday™, Oracle on Demand™, Taleo™, Yammer™, and Concur™. Cloud services provide functionality to users that is implemented in the cloud and that is the target of policies, e.g., logging in, editing documents, downloading bulk data, reading customer contact information, entering payables, deleting documents, in contrast to the offerings of a simple website and ecommerce sites. Note that some consumer facing websites, e.g., Facebook™ and Yammer™, which offer social networks are the type of cloud service considered here. Some services, e.g., Google's Gmail™ can be a hybrid with some free users using the application generally while other corporations use it as a cloud service. Note that implementations can support both web browser clients and application clients that use URL-based APIs. Thus, using Dropbox™ as an example, user activity on the Dropbox™ website, as well as activity of the Dropbox™ client on the computer could be monitored.

As used herein, an “application programming interface (API)” is defined as a packaged collection of code libraries, routines, protocols methods and fields that belong to a set of classes, including its interface types. The API defines the way that developers and programmers can use the classes for their own software development, just by importing the relevant classes and writing statements that instantiate the classes and call their methods and fields. In another implementation, an API is a source code-based specification intended to be used as an interface by software components to communicate with each other. An API can include specifications for routines, data structures, object classes and variables. Basically, an API provides an interface for developers and programmers to access the underlying platform capabilities and features of online social networks. Implementations of the technology disclosed include different types of APIs, including web service APIs such as HTTP or HTTPs based APIs like SOAP, Bulk, XML-RPC and JSON-RPC and REST APIs (e.g., Flickr™ Google Static Maps™, Google Geolocation™), web socket APIs, library-based APIs like JavaScript and TWAIN (e.g., Google Maps™ JavaScript API, Dropbox™ JavaScript Data store API, Twilio™ APIs, Oracle Call Interface (OCI)), class-based APIs (object orientation) like Java API and Android API (e.g., Google Maps™ Android API, MSDN Class Library for .NET Framework, Twilio™ APIs for Java and C #), OS functions and routines like access to file system and access to user interface, object remoting APIs like CORBA and .NET Remoting and hardware APIs like video acceleration, hard disk drives and PCI buses. Other examples of APIs used by the technology disclosed include Box Content API™, Microsoft Graph™, Dropbox API™, Dropbox API v2™, Dropbox Core API™, Dropbox Core API v2™, Facebook Graph API™, Foursquare API™, Geonames API™, Force.com API™, Force.com Metadata API™ Apex API™, Visualforce API™, Force.com Enterprise WSDL™, Salesforce.com Streaming API™, Salesforce.com Tooling API™, Google Drive API™, Drive REST API™, AccuWeather API™, aggregated-single API like CloudRail™ API, and others.

In some implementations, the technology disclosed can be executed using a blockchain network. Regarding blockchain network, blockchain is a distributed and public ledger which maintains records of all the transactions on the blockchain network comprising suppliers of products and services and consumers. Blockchain network is a peer-to-peer network and does not require a central authority or trusted intermediaries to authenticate or to settle the transactions or control the underlying infrastructure. Examples of popular blockchain platforms include Ethereum™, Eris™, Multichain™, Bitcoin™, Hyperledger Fabric™, and Hyperledger Corda™. Blockchain network includes a distributed data structure comprising a chain of blocks.

Blockchain acts as a distributed database or a public ledger which maintains records of all transactions on a peer-to-peer network. A blockchain is maintained by a network of nodes where every node executes and records the same transactions. The blockchain structure is replicated among the nodes in the network. Any node in the network can read the transactions. The transactions are time-stamped and bundled into blocks where each block is identified by its cryptographic hash called the nonce. The blocks form a linear sequence where each block references the hash of the previous or parent block, forming a chain of blocks called the blockchain. Each block maintains records of all the transactions on the network received since the creation of its previous block. Instead of storing the information on all the transactions within the block itself, a special data structure called a Merkle tree is used to store the transactions and only the hash of the root of the Merkle tree is stored in the block.

New blocks are created and added to the blockchain in a process called mining. The nodes in the blockchain network that perform the mining operations are called miners. New transactions are broadcast to all the nodes on the network. Each miner node creates its own block by collecting the new transactions and then finds a proof-of-work (PoW) for its block by performing complex cryptographic computations. The miners validate the transactions and reach a consensus on the block that should be added next to the blockchain. The newly mined block, called the winning block, is then broadcast to the entire network. The winning block is the one that contains a PoW of a given difficulty.

Blockchain is an immutable and durable data structure which maintains a record of the transactions that are tamper resistant. Once a transaction is recorded in a block, it cannot be altered or deleted as long as a majority of the computational power of the network is not controlled by peers who collude to alter the blockchain.

While each miner on the blockchain network can create its own block, only the block which has a PoW of a given difficulty is accepted to be added to the blockchain. The consensus mechanism ensures that all the nodes agree on the same block to contain the canonical transactions. Blockchain offers enhanced security as compared to centralized systems as every transaction is verified by multiple miners. The integrity of the transaction data recorded in the blocks is protected through strong cryptography. In addition to the transaction data, each block contains a cryptographic hash of itself and the hash of the previous block. Any attempts to modify a transaction would result in a change in the hash and would require all the subsequent blocks to be recomputed. This would be extremely difficult to achieve as long as the majority of miners do not cooperate to attack the network.

Blockchain network can host smart contracts. A smart contract is a piece of code that resides on blockchain and is identified by a unique address. A smart contract includes a set of executable functions and state variables. The function code is executed when transactions are sent to the functions. The transactions include input parameters which are required by the functions in the contract. Upon the execution of a function, the state variables in the contract change depending on the logic implemented in the function. Smart contracts can be written in various high-level languages (such as Solidity™ or Python™). Language-specific compilers for smart contracts (such as Solidity™ or Serpent™ compilers) are used to compile the contracts into bytecode. Once compiled, the contracts are uploaded to the blockchain network which assigns a unique address to each contract.

Decentralized applications (DApps) are applications that use smart contracts. DApps provide a user-friendly interface to smart contracts. A cryptocurrency application is an example of a DApp that runs on the blockchain network. A DApp comprises smart contracts and files for web user interface front-end (e.g., HTML, JavaScript, stylesheets, and images). In implementations, DApps also serve as machine-interfaces directly accessible by devices, e.g., via application programming interfaces (APIs) responsive to Hypertext Transfer Protocol (HTTP) requests.

Device(s) can leverage blockchain platforms to enable device-to-device and consumer-to-device transactions. Devices(s) can have their own blockchain accounts and associated smart contracts. The smart contracts can store information on the device identities and usage patterns. Device(s) can send transactions to the associated smart contracts and receive transactions from the peers on the blockchain network. This can be achieved by running a blockchain client on the device(s) that uses a controller service to connect the device(s) to the blockchain network. An example of a blockchain client is EthJsonRpc Python™ client for Ethereum™ that uses JSON-based remote procedure calls (RPCs) to implement client-specific methods and provides a high-level interface to create smart contracts on Ethereum™ and to call contract functions. When users wish to avail the services of the device(s), they can transact with the smart contracts associated with the device(s).

One example of the artificial intelligence logic 108 is a neural network system. In one implementation, the neural network system processes the input representations as input and generates the output representations as output. In some implementations, the neural network system is at least one of a language model neural network, a sequence-to-sequence neural network, an encoder-decoder neural network, an autoencoder neural network, a variational autoencoder neural network, a generative adversarial neural network, a diffusion neural network, a Transformer neural network, a recurrent neural network, a long-short term memory neural network, an autoregressive neural network, an energy-based neural network, and a flow-based neural network.

In one implementation, the artificial intelligence logic 108 is a multilayer perceptron (MLP). In another implementation, the artificial intelligence logic 108 is a feedforward neural network. In yet another implementation, the artificial intelligence logic 108 is a fully-connected neural network. In a further implementation, the artificial intelligence logic 108 is a fully convolution neural network. In a yet further implementation, the artificial intelligence logic 108 is a semantic segmentation neural network. In a yet another further implementation, the artificial intelligence logic 108 is a generative adversarial network (GAN) (e.g., CycleGAN, StyleGAN, pixelRNN, text-2-image, DiscoGAN, IsGAN). In a yet another implementation, the artificial intelligence logic 108 includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the artificial intelligence logic 108 is a convolution neural network (CNN) with a plurality of convolution layers. In another implementation, the artificial intelligence logic 108 is a recurrent neural network (RNN) such as a long short-term memory network (LSTM), bi-directional LSTM (Bi-LSTM), or a gated recurrent unit (GRU). In yet another implementation, the artificial intelligence logic 108 includes both a CNN and an RNN.

In yet other implementations, the artificial intelligence logic 108 can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The artificial intelligence logic 108 can use one or more loss functions such as logistic regression/log loss, multi-class cross-entropy/softmax loss, binary cross-entropy loss, mean-squared error loss, L1 loss, L2 loss, smooth L1 loss, and Huber loss. The artificial intelligence logic 108 can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The artificial intelligence logic 108 can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tan h)), batch normalization layers, regularization layers, dropout, pooling layers (e.g., max or average pooling), global average pooling layers, and attention mechanisms.

The artificial intelligence logic 108 can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The artificial intelligence logic 108 can be an ensemble of multiple models, in some implementations.

In some implementations, the artificial intelligence logic 108 can be trained using backpropagation-based gradient update techniques. Example gradient descent techniques that can be used for training the artificial intelligence logic 108 include stochastic gradient descent, batch gradient descent, and mini-batch gradient descent. Some examples of gradient descent optimization algorithms that can be used to train the artificial intelligence logic 108 are Momentum, Nesterov accelerated gradient, Adagrad, Adadelta, RMSprop, Adam, AdaMax, Nadam, and AMSGrad.

The universal contracts datastore 112 stores a plurality of universal contracts (e.g., NDAs). A universal contract is configured to represent a family of contract variants, and has universal terms and conditions that, once opted-in, are binding across a multitude of transactions.

### Universal Contract Construction

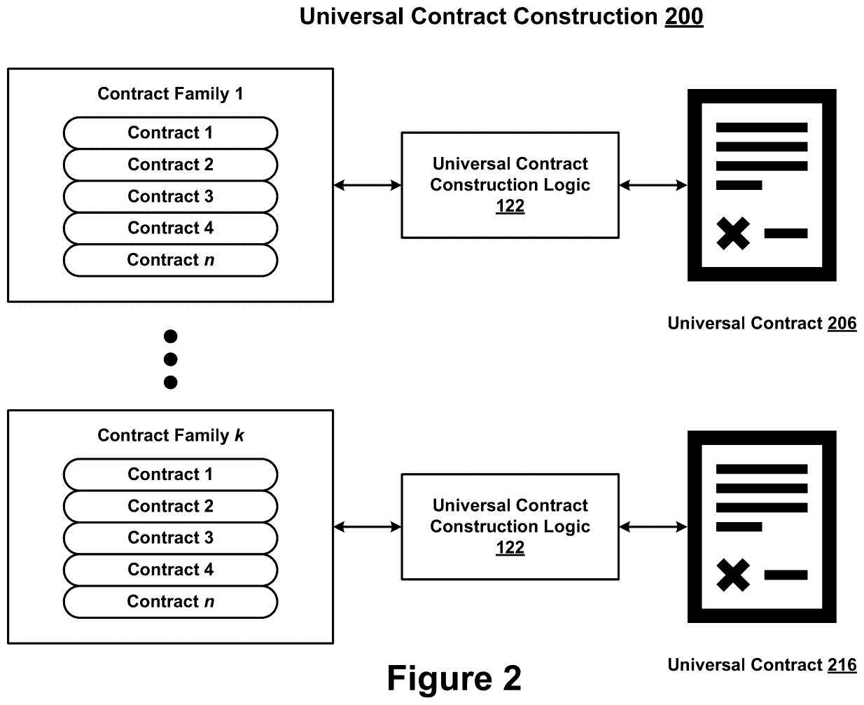

FIG. 2 shows one implementation of the disclosed universal contract construction 200. The universal contract construction logic 122 is configured to analyze terms and conditions spanning contract variants in the associated family 1-k of contract variants 1-n, and, based on the analysis of the terms and conditions, to construct universal terms and conditions of the associated universal contract 206-216 that take into account the terms and conditions spanning the contract variants.

### Opt-In Network

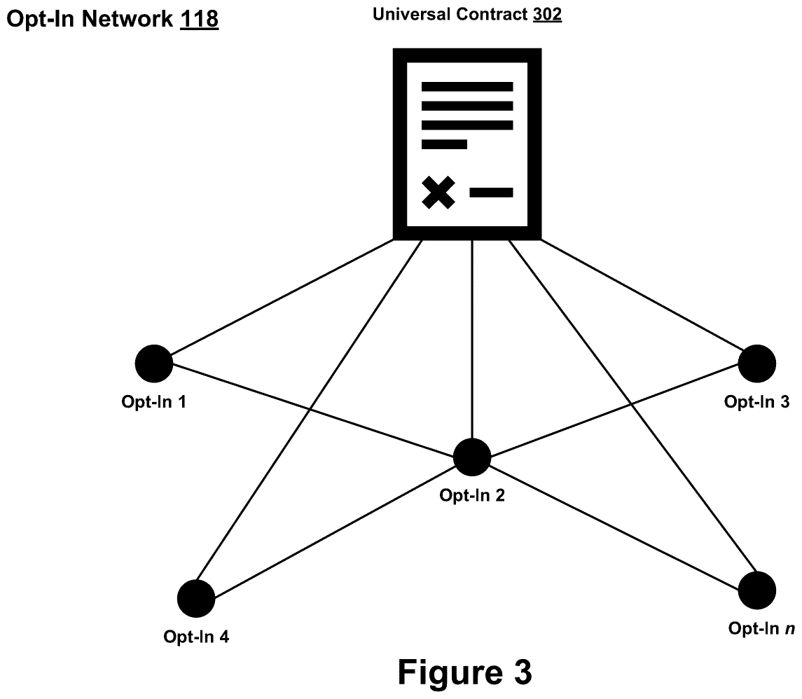

FIG. 3 portrays one implementation of the disclosed opt-in network 118. The opt-in network construction logic 128 is configured to receive respective opt-ins from the respective entities 125 into an associated universal contract 302 representing an associated family of contract variants. The opt-in network construction logic 128 is further configured to construct the opt-in network 118 of the respective entities 125 such that the associated universal contract 302 is binding across a multitude of transactions between the respective entities 125, thereby obviating re-execution of the associated universal contract across the multiple of transactions.

The registry construction logic 102 is configured to map the opt-in network 118, the associated universal contract 302, and the respective entities 125 in the registry, roster, or directory of entities opting into a universal contract 105.

A universal contract update logic is configured to monitor amendments made to the universal terms and conditions of the associated universal contract by one or more entities in the respective entities during one or more transactions in the multitude of transactions, and to update the associated universal contract to incorporate the amendments. A particular amendment to the universal terms and conditions of the associated universal contract is incorporated after the particular amendment is implemented at least a threshold number of times by the one or more entities in the respective entities.

In some implementations, the system 100 is hosted on a cloud network. In other implementations, the system 100 is hosted on a blockchain network.

### Method

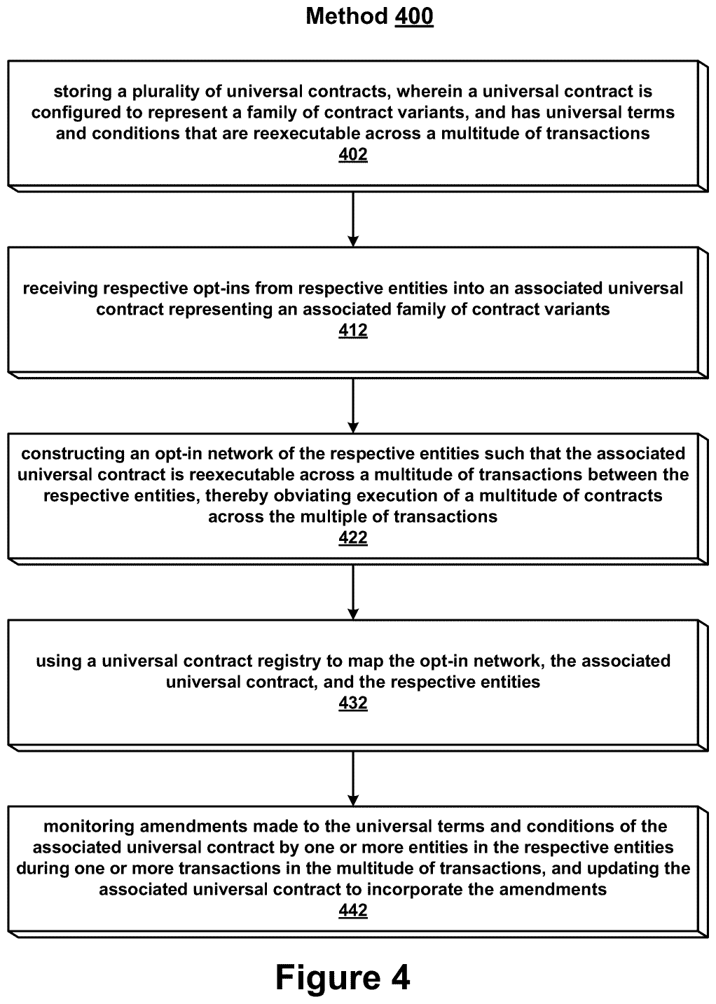

FIG. 4 depicts one implementation of a computer-implemented method 400 of the technology disclosed.

At action 402, the method 400 includes storing a plurality of universal contracts. A universal contract is configured to represent a family of contract variants, and has universal terms and conditions that, once opted-in, are binding across a multitude of transactions.

At action 412, the method 400 further includes receiving respective opt-ins from respective entities into an associated universal contract representing an associated family of contract variants.

At action 422, the method 400 further includes constructing an opt-in network of the respective entities such that the associated universal contract is binding across a multitude of transactions between the respective entities, thereby obviating re-execution of the associated universal contract across the multiple of transactions.

At action 432, the method 400 further includes using a registry, roster, or directory of entities opting into a universal contract to map the opt-in network, the associated universal contract, and the respective entities.

At action 442, the method 400 further includes monitoring amendments made to the universal terms and conditions of the associated universal contract by one or more entities in the respective entities during one or more transactions in the multitude of transactions, and updating the associated universal contract to incorporate the amendments.

### Computer System

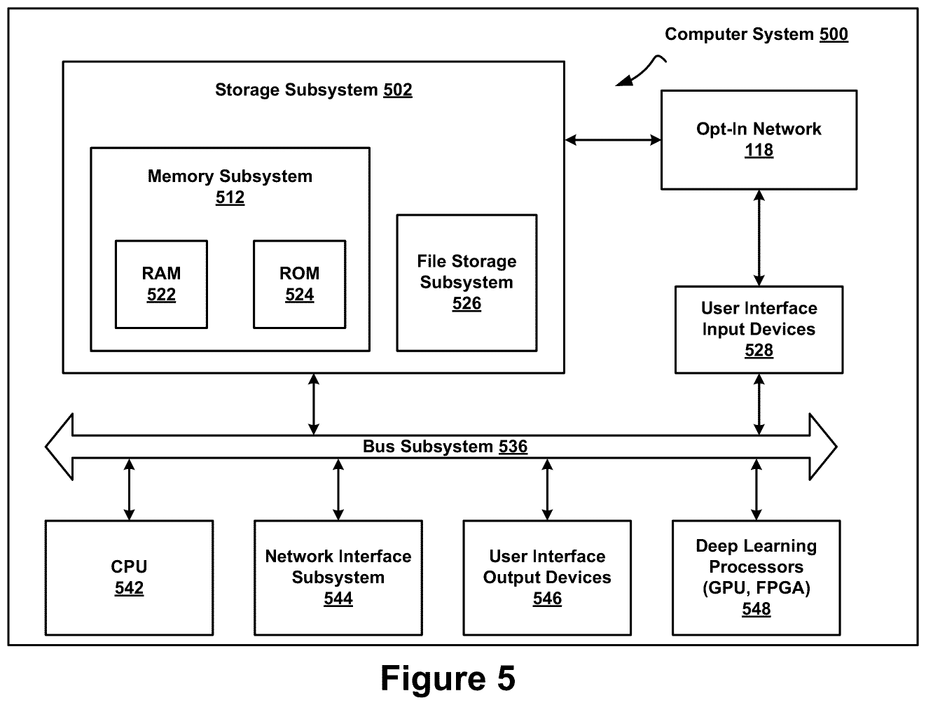

FIG. 5 shows an example computer system 500 that can be used to implement the technology disclosed. Computer system 500 includes at least one central processing unit (CPU) 542 that communicates with a number of peripheral devices via bus subsystem 526. These peripheral devices can include a storage subsystem 502 including, for example, memory devices and a file storage subsystem 526, user interface input devices 528, user interface output devices 546, and a network interface subsystem 544. The input and output devices allow user interaction with computer system 500. Network interface subsystem 544 provides an interface to outside networks, including an interface to corresponding interface devices in other computer systems.

In one implementation, the opt-in network is communicably linked to the storage subsystem 502 and the user interface input devices 528.

User interface input devices 528 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 500.

User interface output devices 546 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 500 to the user or to another machine or computer system.

Storage subsystem 502 stores programming and data constructs that provide the functionality of some or all of the modules and methods described herein. These software modules are generally executed by processors 548.

Processors 548 can be graphics processing units (GPUs), field-programmable gate arrays (FPGAs), application-specific integrated circuits (ASICs), and/or coarse-grained reconfigurable architectures (CGRAs). Processors 548 can be hosted by a deep learning cloud platform such as Google Cloud Platform™, Xilinx™, and Cirrascale™. Examples of processors 548 include Google's Tensor Processing Unit (TPU)™, rackmount solutions like GX4 Rackmount Series™, GX5 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 512 used in the storage subsystem 502 can include a number of memories including a main random access memory (RAM) 522 for storage of instructions and data during program execution and a read only memory (ROM) 524 in which fixed instructions are stored. A file storage subsystem 526 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 526 in the storage subsystem 502, or in other machines accessible by the processor.

Bus subsystem 536 provides a mechanism for letting the various components and subsystems of computer system 500 communicate with each other as intended. Although bus subsystem 536 is shown schematically as a single bus, alternative implementations of the bus subsystem can use multiple busses.

Computer system 500 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 500 depicted in FIG. 5 is intended only as a specific example for purposes of illustrating the preferred implementations of the present invention. Many other configurations of computer system 500 are possible having more or less components than the computer system depicted in FIG. 5.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, the artificial intelligence logic 108 is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 5 is a schematic of an exemplary computing node. Computing node 500 is only one example of a suitable computing node and is not intended to suggest any limitation as to the scope of use or functionality of embodiments described herein. Regardless, computing node 500 is capable of being implemented and/or performing any of the functionality set forth hereinabove.

In computing node 500 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 5, computer system/server in computing node 500 is shown in the form of a general-purpose computing device. The components of computer system/server may include, but are not limited to, one or more processors or processing units, a system memory, and a bus that couples various system components including system memory to processor.

The Bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

### CLAUSE SET 1

1. A system, comprising:
   a memory storing a plurality of universal contracts, wherein a universal contract is configured to represent a family of contract variants, and has universal terms and conditions that, once opted-in, are binding across a multitude of transactions; and an opt-in network construction logic configured to receive respective opt-ins from respective
   entities into an associated universal contract representing an associated family of contract variants, and to construct an opt-in network of the respective entities such that the associated universal contract is binding across a multitude of transactions between the respective entities, thereby obviating re-execution of the associated universal contract across the multitude of transactions.
2. The system of clause 1, further configured to comprise a universal contract roster (or registry or directory) configured to map the opt-in network, the associated universal contract, and the respective entities.
3. The system of clause 1, further configured to comprise a universal contract construction logic configured to analyze terms and conditions spanning contract variants in the associated family of contract variants, and, based on the analysis of the terms and conditions, to construct universal terms and conditions of the associated universal contract that take into account the terms and conditions spanning the contract variants.
4. The system of clause 3, further configured to comprise a universal contract update logic configured to monitor amendments made to the universal terms and conditions of the associated universal contract by one or more entities in the respective entities during one or more transactions in the multitude of transactions, and to update the associated universal contract to incorporate the amendments.
5. The system of clause 4, wherein a particular amendment to the universal terms and conditions of the associated universal contract is incorporated after the particular amendment is implemented at least a threshold number of times by the one or more entities in the respective entities.
6. The system of clause 1, wherein the memory and the opt-in network are hosted on a cloud network.
7. The system of clause 1, wherein the memory and the opt-in network are hosted on a blockchain network.
8. A computer-implemented method, including:
   storing a plurality of universal contracts, wherein a universal contract is configured to represent a family of contract variants, and has universal terms and conditions that, once opted-in, are binding across a multitude of transactions; and
   receiving respective opt-ins from respective entities into an associated universal contract representing an associated family of contract variants, and constructing an opt-in network of the respective entities such that the associated universal contract is binding across a multitude of transactions between the respective entities, thereby obviating re-execution of the associated universal contract across the multitude of transactions.
9. The computer-implemented method of clause 8, further including using a universal contract roster (or registry or directory) to map the opt-in network, the associated universal contract, and the respective entities.
10. The computer-implemented method of clause 8, further including analyzing terms and conditions spanning contract variants in the associated family of contract variants, and, based on the analysis of the terms and conditions, constructing universal terms and conditions of the associated universal contract that take into account the terms and conditions spanning the contract variants.
11. The computer-implemented method of clause 10, further including monitoring amendments made to the universal terms and conditions of the associated universal contract by one or more entities in the respective entities during one or more transactions in the multitude of transactions, and updating the associated universal contract to incorporate the amendments.
12. The computer-implemented method of clause 11, wherein a particular amendment to the universal terms and conditions of the associated universal contract is incorporated after the particular amendment is implemented at least a threshold number of times by the one or more entities in the respective entities.
13. The computer-implemented method of clause 8, wherein the plurality of universal contracts and the opt-in network are hosted on a cloud network.
14. The computer-implemented method of clause 8, wherein the plurality of universal contracts and the opt-in network are hosted on a blockchain network.
15. A non-transitory computer readable storage medium impressed with computer program instructions, the instructions, when executed on a processor, implement a method comprising:
   setting up a universal contract, wherein the universal contract is configured to represent a family of contract variants, and has universal terms and conditions that are binding across a multitude of transactions; and
   receiving respective opt-ins from respective entities into the universal contract, and constructing an opt-in network of the respective entities such that the universal contract is binding across respective transactions between an executing entity and the respective entities, without a need of executing respective contracts for the respective transactions between an executing entity and the respective entities.
16. The non-transitory computer readable storage medium of clause 15, implementing the method further comprising using a universal contract roster to map the opt-in network, the universal contract, and the respective entities.
17. The non-transitory computer readable storage medium of clause 15, implementing the method further comprising analyzing terms and conditions spanning contract variants in the family of contract variants, and, based on the analysis of the terms and conditions, constructing universal terms and conditions of the universal contract that take into account the terms and conditions spanning the contract variants.
18. The non-transitory computer readable storage medium of clause 17, implementing the method further comprising monitoring amendments made to the universal terms and conditions of the universal contract by one or more entities in the respective entities during one or more transactions in the respective transactions, and updating the universal contract to incorporate the amendments.
19. The non-transitory computer readable storage medium of clause 18, wherein a particular amendment to the universal terms and conditions of the universal contract is incorporated after the particular amendment is implemented at least a threshold number of times by the one or more entities in the respective entities.
20. The non-transitory computer readable storage medium of clause 15, wherein the plurality of universal contracts and the opt-in network are hosted on a cloud network, and wherein the plurality of universal contracts and the opt-in network are hosted on a blockchain network.

### CLAUSE SET 2

1. A system, comprising:
   a memory storing a plurality of universal contracts, wherein a universal contract is configured to represent a family of contract variants, and has universal terms and conditions that, once opted-in, are binding across a multitude of transactions between opted-in entities; and
   a registry, roster, or directory of entities opting into a universal contract that may form an opt-in network construction logic configured to receive respective opt-ins from respective entities into an associated universal contract representing an associated family of contract variants, and to construct an opt-in network of the respective entities such that the associated universal contract is binding across a multitude of transactions between the respective entities, thereby obviating re-execution of the associated universal contract across the multiple of transactions.
2. The system of clause 1, further configured to comprise a registry, roster, or directory of entities opting into a universal contract construction logic configured to map the opt-in network, the associated universal contract, and the respective entities in a universal contract.
3. The system of clause 1, further configured to comprise a universal contract construction logic configured to analyze terms and conditions spanning contract variants in the associated family of contract variants, and, based on the analysis of the terms and conditions, to construct universal terms and conditions of the associated universal contract that take into account the terms and conditions spanning the contract variants.
4. The system of clause 3, further configured to comprise a universal contract update logic configured to monitor amendments made to the universal terms and conditions of the associated universal contract by one or more entities in the respective entities during one or more transactions in the multitude of transactions, and to update the associated universal contract to incorporate the amendments.
5. The system of clause 4, wherein a particular amendment to the universal terms and conditions of the associated universal contract is incorporated after the particular amendment is implemented at least a threshold number of times by the one or more entities in the respective entities.
6. The system of clause 1, wherein the memory and the opt-in network are hosted on a cloud network.
7. The system of clause 1, wherein the memory and the opt-in network are hosted on a blockchain network.
8. A computer-implemented method, including:
   storing a plurality of universal contracts, wherein a universal contract is configured to represent a family of contract variants, and has universal terms and conditions that are binding across a multitude of transactions; and
   receiving respective opt-ins from respective entities into an associated universal contract representing an associated family of contract variants, and constructing an opt-in network of the respective entities such that the associated universal contract is binding across a multitude of transactions between the respective entities, thereby obviating re-execution of the associated universal contract across the multiple of transactions.
9. The computer-implemented method of clause 8, further including using a registry, roster, or directory of entities opting into a universal contract to map the opt-in network, the associated universal contract, and the respective entities.
10. The computer-implemented method of clause 8, further including analyzing terms and conditions spanning contract variants in the associated family of contract variants, and, based on the analysis of the terms and conditions, constructing universal terms and conditions of the associated universal contract that take into account the terms and conditions spanning the contract variants.
11. The computer-implemented method of clause 10, further including monitoring amendments made to the universal terms and conditions of the associated universal contract by one or more entities in the respective entities during one or more transactions in the multitude of transactions, and updating the associated universal contract to incorporate the amendments.
12. The computer-implemented method of clause 11, wherein a particular amendment to the universal terms and conditions of the associated universal contract is incorporated after the particular amendment is implemented at least a threshold number of times by the one or more entities in the respective entities.
13. The computer-implemented method of clause 8, wherein the plurality of universal contracts and the opt-in network are hosted on a cloud network.
14. The computer-implemented method of clause 8, wherein the plurality of universal contracts and the opt-in network are hosted on a blockchain network.

What is claimed is:

1. A system, comprising:
a memory storing a plurality of universal contracts, wherein a universal contract is configured to represent a family of contract variants, and has universal terms and conditions that, once opted-in, are binding across a multitude of transactions; and
an opt-in network construction logic configured to receive respective opt-ins from respective entities into an associated universal contract representing an associated family of contract variants, and to construct an opt-in network of the respective entities such that the associated universal contract is binding across a multitude of transactions between the respective entities, thereby obviating re-execution of the associated universal contract across the multitude of transactions.

2. The system of claim 1, further configured to comprise a roster construction logic configured to map the opt-in network, the associated universal contract, and the respective entities in a universal contract roster.

3. The system of claim 1, further configured to comprise a universal contract construction logic configured to analyze terms and conditions spanning contract variants in the associated family of contract variants, and, based on the analysis of the terms and conditions, to construct universal terms and conditions of the associated universal contract that take into account the terms and conditions spanning the contract variants.

4. The system of claim 3, further configured to comprise a universal contract update logic configured to monitor amendments made to the universal terms and conditions of the associated universal contract by one or more entities in the respective entities during one or more transactions in the multitude of transactions, and to update the associated universal contract to incorporate the amendments.

5. The system of claim 4, wherein a particular amendment to the universal terms and conditions of the associated universal contract is incorporated after the particular amendment is implemented at least a threshold number of times by the one or more entities in the respective entities.

6. The system of claim 1, wherein the memory and the opt-in network are hosted on a cloud network.

7. The system of claim 1, wherein the memory and the opt-in network are hosted on a blockchain network.

8. A computer-implemented method, including:
storing a plurality of universal contracts, wherein a universal contract is configured to represent a family of contract variants, and has universal terms and conditions that are binding across a multitude of transactions; and
receiving respective opt-ins from respective entities into an associated universal contract representing an associated family of contract variants, and constructing an opt-in network of the respective entities such that the associated universal contract is binding across a multitude of transactions between the respective entities, thereby obviating re-execution of the associated universal contract across the multitude of transactions.

9. The computer-implemented method of claim 8, further including using a universal contract roster to map the opt-in network, the associated universal contract, and the respective entities.

10. The computer-implemented method of claim 8, further including analyzing terms and conditions spanning contract variants in the associated family of contract variants, and, based on the analysis of the terms and conditions, constructing universal terms and conditions of the associated universal contract that take into account the terms and conditions spanning the contract variants.

11. The computer-implemented method of claim 10, further including monitoring amendments made to the universal terms and conditions of the associated universal contract by one or more entities in the respective entities during one or more transactions in the multitude of transactions, and updating the associated universal contract to incorporate the amendments.

12. The computer-implemented method of claim 11, wherein a particular amendment to the universal terms and conditions of the associated universal contract is incorporated after the particular amendment is implemented at least a threshold number of times by the one or more entities in the respective entities.

13. The computer-implemented method of claim 8, wherein the plurality of universal contracts and the opt-in network are hosted on a cloud network.

14. The computer-implemented method of claim 8, wherein the plurality of universal contracts and the opt-in network are hosted on a blockchain network.

15. A non-transitory computer readable storage medium impressed with computer program instructions, the instructions, when executed on a processor, implement a method comprising:
setting up a universal contract, wherein the universal contract is configured to represent a family of contract variants, and has universal terms and conditions that are binding across a multitude of transactions; and
receiving respective opt-ins from respective entities into the universal contract, and constructing an opt-in network of the respective entities such that the universal contract is binding across respective transactions between an executing entity and the respective entities, without a need of executing respective contracts for the respective transactions between an executing entity and the respective entities.

16. The non-transitory computer readable storage medium of claim 15, implementing the method further comprising using a universal contract roster to map the opt-in network, the universal contract, and the respective entities.

17. The non-transitory computer readable storage medium of claim 15, implementing the method further comprising analyzing terms and conditions spanning contract variants in the family of contract variants, and, based on the analysis of the terms and conditions, constructing universal terms and conditions of the universal contract that take into account the terms and conditions spanning the contract variants.

18. The non-transitory computer readable storage medium of claim 17, implementing the method further comprising monitoring amendments made to the universal terms and conditions of the universal contract by one or more entities in the respective entities during one or more transactions in the respective transactions, and updating the universal contract to incorporate the amendments.

19. The non-transitory computer readable storage medium of claim 18, wherein a particular amendment to the universal terms and conditions of the universal contract is incorporated after the particular amendment is implemented at least a threshold number of times by the one or more entities in the respective entities.

20. The non-transitory computer readable storage medium of claim 15, wherein the plurality of universal contracts and the opt-in network are hosted on a cloud network, and wherein the plurality of universal contracts and the opt-in network are hosted on a blockchain network.
